(19) United States
(12) Patent Application Publication
(10) Pub. No.: US 2013/0265141 A1
(43) Pub. Date: Oct. 10, 2013

(54) SYSTEMS AND METHODS FOR MULTIPLE FREQUENCY BAND RFID

(71) Applicant: Karen M. Etzkorn, St. Louis, MO (US)

(72) Inventor: Karen M. Etzkorn, St. Louis, MO (US)

(21) Appl. No.: 13/442,495

(22) Filed: Apr. 9, 2012

(51) Int. Cl. G06K 7/01

(52) U.S. Cl. 340/10.6; 340/10.1

(57) ABSTRACT

A radio-frequency identification (RFID) reader is provided. The RFID reader includes a transmitter/receiver module configured to transmit a radio signal on a plurality of frequency bands, and a control module configured to receive a geographic location, determine an authorized frequency band associated with the geographic location, and instruct the transmitter/receiver module to transmit the radio signal on the authorized frequency band.

### BACKGROUND

The field of the disclosure relates generally to radio-frequency identification (RFID) systems, and more specifically, to an RFID reader for transmitting radio signals on a plurality of frequency bands.

RFID systems utilize RFID readers and RFID tags. The RFID reader interrogates an RFID tag by transmitting a radio signal to the tag and receiving a response radio signal form the tag. The radio response signal may include information about an object to which the RFID tag is attached. Accordingly, by interrogating a plurality of RFID tags, information about a plurality of objects can be retrieved relatively quickly.

However, many countries regulate the frequencies at which RFID systems are authorized to operate. Accordingly, at least some known RFID readers are only capable of operating in a limited geographic range. Thus, it is relatively expensive to operate RFID systems on mobile platforms that frequently change their location, such as vehicles, as such RFID systems may require multiple dedicated RFID readers each capable of operation in a limited geographic area.

Accordingly, instead of implementing RFID systems on vehicles, items are often manually checked. However, manually checking items such as safety equipment and/or maintenance equipment may take considerable time and/or effort. Further, manually checking items may result in human error, making manual checks somewhat unreliable.

### BRIEF DESCRIPTION

In one aspect, a radio-frequency identification (RFID) reader is provided. The RFID reader includes a transmitter/receiver module configured to transmit a radio signal on a plurality of frequency bands, and a control module configured to receive a geographic location, determine an authorized frequency band associated with the geographic location, and instruct the transmitter/receiver module to transmit the radio signal on the authorized frequency band.

In another aspect, a processing device is provided. The processing device is configured to receive a geographic location, determine an authorized frequency band associated with the geographic location, and instruct a transmitter/receiver module of a radio-frequency identification (RFID) reader to transmit a radio signal on the authorized frequency band.

In yet another aspect, a method for transmitting a radio signal from a radio-frequency identification (RFID) reader is provided. The method includes receiving, at a processing device, a geographic location, determining, using the processing device, an authorized frequency band associated with the geographic location, and instructing a transmitter/receiver module of the RFID reader to transmit a radio signal on the authorized frequency band.

The features, functions, and advantages that have been discussed can be achieved independently in various embodiments or may be combined in yet other embodiments, further details of which can be seen with reference to the following description and drawings.

### BRIEF DESCRIPTION OF THE DRAWINGS

FIG. 1 is a schematic diagram of an exemplary RFID system.

FIG. 2 is a block diagram of an exemplary RFID reader that may be used with the system shown in FIG. 1.

FIG. 3 is a flowchart of an exemplary method for transmitting a radio signal that may be used with the RFID system shown in FIG. 1.

### DETAILED DESCRIPTION

The systems and methods described herein facilitate operation of an RFID reader. The RFID reader determines an authorized frequency band based on the geographic location of the RFID reader. A transmitter/receiver unit of the RFID reader operates at the authorized frequency band. Accordingly, the RFID reader is capable of operating in a plurality of geographic locations and complying with local frequency regulation.

Technical effects of the methods and systems described herein include at least one of: (a) receiving a geographic location; (b) determining an authorized frequency band associated with the geographic location; and (c) instructing a transmitter/receiver module of an RFID reader to transmit a radio signal on the authorized frequency band.

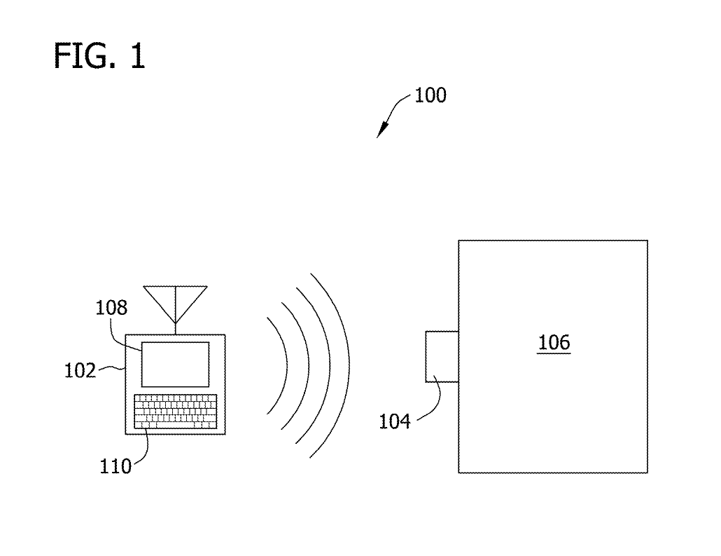

FIG. 1 is a schematic diagram of an exemplary radio-frequency identification (RFID) system 100 that includes an RFID reader 102 and at least one RFID tag 104 attached to and/or included as part of an object 106. In the exemplary embodiment, RFID reader 102 is a fixed reader that is mounted and/or installed in an operating environment, such as vehicle. Alternatively, RFID reader 102 may be a portable, handheld reader. RFID reader 102 includes a display 108 for displaying information and a user input device 110, such as a keyboard, for receiving input from a user.

Notably, different geographic locations may have different frequency management regulations for RFID operations, and accordingly, different authorized frequency bands on which RFID readers, such as RFID reader 102, are permitted to operate. As described in detail herein, to ensure compliance with frequency management regulations in a plurality of geographic locations, RFID reader 102 is configured to determine the current geographic location and operate on the authorized frequency band associated with that geographic location. As such, RFID reader 102 enables compliance with frequency regulations even in an operating environment that frequently changes geographic location, such as an aircraft.

Interrogating RFID tag 104 using RFID reader 102 enables identification of object 106. To interrogate RFID tag 104, RFID reader 102 transmits an interrogation radio signal. The interrogation radio signal is transmitted within a particular frequency band. As described in detail below, the frequency band at which RFID reader 102 transmits the interrogation radio signal can be selectively changed. Accordingly, RFID reader 102 is capable of transmitting an interrogation radio signal in multiple frequency bands.

When RFID tag 104 receives the transmitted radio signal from RFID reader 102, RFID tag 104 emits a response radio signal. Specifically, the RFID tag 104 includes a receiver (not shown) for receiving the interrogation radio signal, and a transmitter (not shown) for transmitting the response radio signal. The response radio signal includes identification information related to object 106. For example, the response radio signal may include a unique tag serial number, an expiration date of object 106, a stock number of object 106, a lot or batch number of object 106, a position and/or location of object 106, and/or other information pertinent to object 106. RFID tag 104 can be detected at a wide range of frequencies. For example, in at least some embodiments, RFID tag 104 is operable from 850 to 960 megahertz (MHz).

Object 106 may be any article for which it is desirable to obtain information about the article. For example, in some embodiments, system 100 is implemented onboard a moving vehicle, such as an aircraft. In an aircraft operating environment, object 106 may be aircraft maintenance equipment, aircraft safety equipment, and/or other aircraft articles. For example, object 106 could be a seat, seatbelt, a flotation device, an oxygen mask, a fire extinguisher, and/or any other suitable article.

The response radio signal transmitted from RFID tag 104 is received by RFID reader 102. In the exemplary embodiment, RFID reader 102 transmits the received radio response signal to a computer system (not shown) running software for extracting the identification information from the response radio signal. Alternatively, RFID reader 102 may include suitable software extracting the identification information from the radio response signal.

In the exemplary embodiment, RFID tag 104 is a passive RFID tag that uses radio energy in the interrogation radio signal to generate and emit the response radio signal. Alternatively, RFID tag 104 may be an active RFID tag that includes a battery that periodically transmits the response radio signal. Further, RFID tag 104 may be read-only or read/write, in which data can be written into RFID tag 104.

Although FIG. 1 shows only one RFID tag 104 attached to one object 106, it will be appreciated that system 100 may include a plurality of RFID tags 104 each attached to a respective object. Accordingly, RFID reader 102 is capable of reading a plurality of RFID tags 104 simultaneously to acquire identification information for a plurality of objects 106.

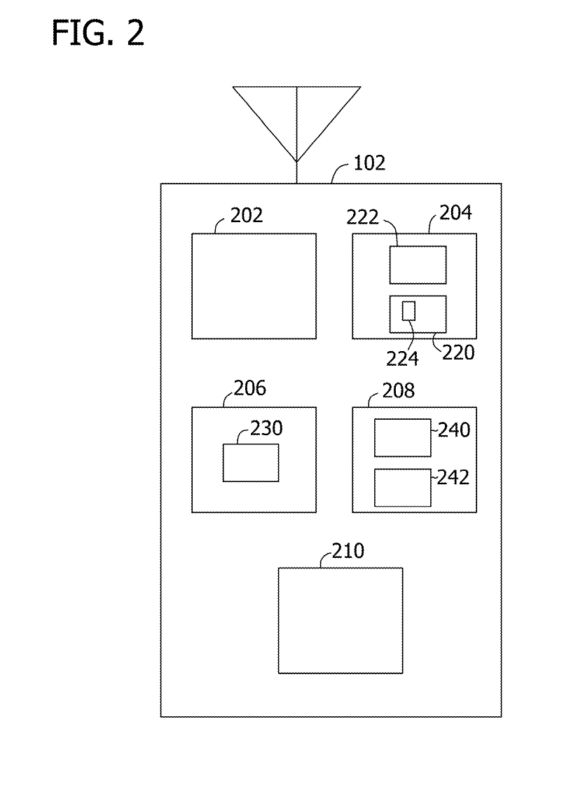

FIG. 2 is a block diagram of RFID reader 102 that may be used with RFID system 100 (shown in FIG. 1). In the exemplary embodiment, RFID reader 102 includes a transmitter/receiver module 202, a control module 204, a sensor module 206, a user interface module 208, and a communications module 210.

Transmitter/receiver module 202 transmits interrogation radio signal and receives response radio signal from RFID tag 104 (shown in FIG. 1). In the exemplary embodiment, transmitter/receiver module 202 is capable of transmitting and receiving radio signals on a plurality of frequency bands. Notably, different countries generally have different frequency management regulations for RFID systems, and accordingly, different authorized frequency bands. For example, RFID systems are authorized to operate in the 902-928 MHz range in the United States, in the 865.6-867.6 MHz range in Europe, and in the 952-956.4 MHz range in Japan. Accordingly, in one embodiment, transmitter/receiver module 202 may be capable of transmitting and receiving radio signals on a first frequency band in the 902-928 MHz range, on a second frequency band in the 865.6-867.6 MHz range, and/or on a third frequency band in the 952-956.4 MHz range. As such, by being able to operate on a plurality of frequency bands, RFID reader 102 can be utilized in a plurality of different geographic locations.

Control module 204 instructs transmitter/receiver module 202 to transmit the interrogation radio signal on a selected frequency band. In the exemplary embodiment, control module 204 includes at least one memory device 220 and a processing device 222 that is coupled to memory device 220 for executing instructions. In some embodiments, executable instructions are stored in memory device 220. Control module 204 performs one or more operations described herein by programming processing device 222. For example, processing device 222 may be programmed by encoding an operation as one or more executable instructions and by providing the executable instructions in memory device 220.

Processing device 222 may include one or more processing units (e.g., in a multi-core configuration). Further, processing device 222 may be implemented using one or more heterogeneous processor systems in which a main processor is present with secondary processors on a single chip. As another illustrative example, processing device 222 may be a symmetric multi-processor system containing multiple processors of the same type. Further, processing device 222 may be implemented using any suitable programmable circuit including one or more systems and microcontrollers, microprocessors, reduced instruction set circuits (RISC), application specific integrated circuits (ASIC), programmable logic circuits, field programmable gate arrays (FPGA), and any other circuit capable of executing the functions described herein. Processing device 222 determines which frequency band control module 204 should instruct transmitter/receiver module 202 to operate in.

Memory device 220 is one or more devices that enable information such as executable instructions and/or other data to be stored and retrieved. Memory device 220 may include one or more computer readable media, such as, without limitation, dynamic random access memory (DRAM), static random access memory (SRAM), a solid state disk, and/or a hard disk. Memory device 220 may be configured to store, without limitation, application source code, application object code, source code portions of interest, object code portions of interest, configuration data, execution events and/or any other type of data.

In the exemplary embodiment, a frequency look-up table 224 is stored on memory device 220. Frequency look-up table 224 includes a list of geographic locations (e.g., countries, continents, cities, states, latitude and longitude pairs, etc.) and the authorized frequency band associated with each geographic location. Processing device 222 determines which frequency band transmitter/receiver module 202 should operate in by utilizing frequency look-up table 224.

Sensor module 206 determines the geographic location of RFID reader 102. Sensor module 206 may determine the geographic location of RFID reader 102 continuously, periodically, and/or upon a user request input using user interface module 208. In the exemplary embodiment, sensor module 206 includes a global positioning system (GPS) sensor 230. GPS sensor 230 determines geopositional information, and accordingly, the geographic location of RFID reader 102. Geopositional information may include, for example, the current latitude, longitude, and/or altitude of RFID reader 102. The geopositional information may be calculated, for example, by communicating with satellites using communications module 210.

In the exemplary embodiment, sensor module 206 transmits the determined geographic location to processing device 222. The determined geographic location may be transmitted from sensor module 206 continuously, periodically, and/or upon a user request input using user interface module 208. When processing device 222 receives the determined geographic location from sensor module 206, processing device 222 determines the authorized frequency band using look-up table 224, and control module 204 instructs transmitter/receiver module 202 to transmit a radio signal on the authorized frequency band.

User interface module 208 includes an input device 240, such as user input device 110 (shown in FIG. 1). Input device 240 may include a toggle switch, a touchscreen, keypad and/or keyboard, and/or mouse that enables a user to enter information and interact with RFID reader 102. Using input device 240, a user can input the geographic location to be used by processing device 222 in determining the authorized frequency band. For example, in one embodiment, using input device 240, the user selects a geographic location from a plurality of preset choices. Further, in some embodiments, the user may input a geographic location by entering (e.g., typing) the desired geographic location using input device 240.

In the exemplary embodiment, user interface module 208 also includes a display device 242, such as display 108 (shown in FIG. 1) that enables a user to view information pertinent to the operation of RFID reader 102. For example, display device 242 may display the current geographic location, the current authorized frequency band, and/or frequency look-up table 224. Display device 242 may include, for example, a cathode ray tube (CRT), a liquid crystal display (LCD), an organic LED (OLED) display, and/or an “electronic ink” display. In some embodiments, a touch screen functions as both display device 242 and input device 240.

When a user inputs a geographic location using input device 240, user interface module 208 transmits the determined geographic location to processing device 222. When processing device 222 receives the determined geographic location from user interface module 208, processing device 222 determines the authorized frequency band using look-up table 224, and control module 204 instructs transmitter/receiver module 202 accordingly. Accordingly, in the exemplary embodiment, processing device 222 is capable of determining the authorized frequency band based on a geographic location determined by sensor module 206 or input by a user using user interface module 208.

Communications module 210 transmits and receives data for RFID reader 102. Communications module 210 transmits and receives data using any suitable communications medium, including, but not limited to, a wired and/or wireless network, an Iridium satellite network, radio, 3G, Controller Pilot Data Link (CPDL), and Tactical Digital Information Links (TADIL). Data transmitted and/or received by communications module 210 may includes identification information received from RFID tag 104 (shown in FIG. 1). In embodiments where RFID reader 102 is located onboard a vehicle, communications module 210 may facilitate communications and integration between RFID reader 102 and one or more vehicle systems. For example, in at least some embodiments, communications module 210 communicates with one or more aircraft flight and/or navigation systems. In such embodiments, sensor module 206 may determine the geographic location of RFID reader 102 by communicating with an aircraft navigation system.

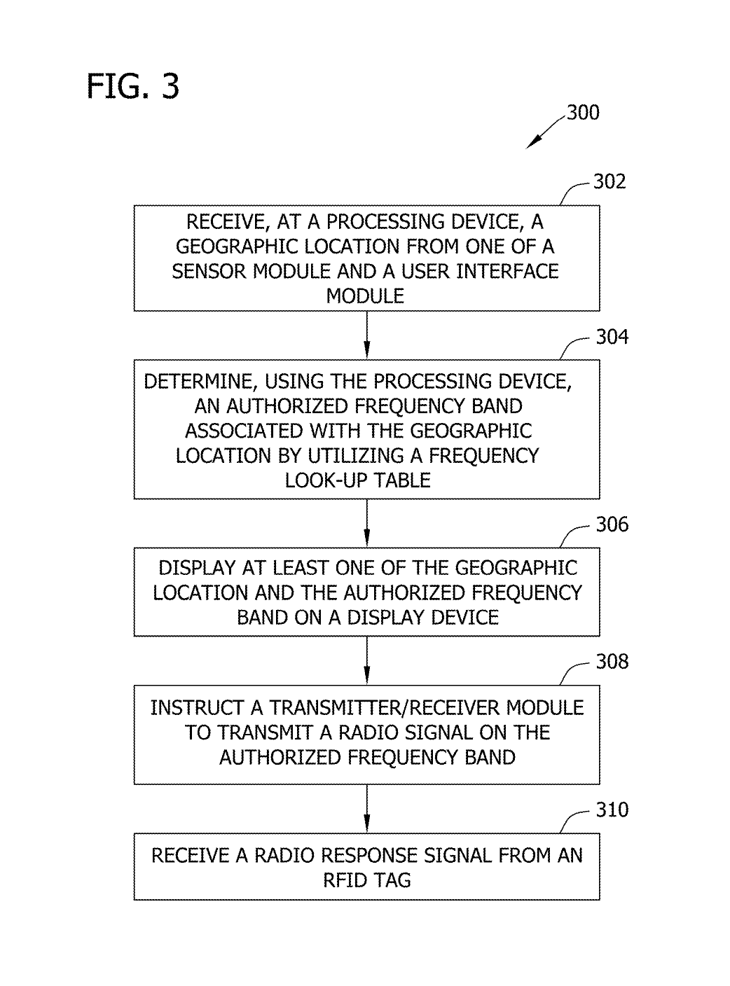

FIG. 3 is a flowchart of an exemplary method 300 for transmitting a radio signal in an RFID system, such as RFID system 100 (shown in FIG. 1). Method includes receiving 302 a geographic location at a processing device, such as processing device 222 (shown in FIG. 2). In the exemplary embodiment, the geographic location is received 302 from a sensor module, such as sensor module 206, or a user interface module, such as user interface module 208 (both shown in FIG. 2). Alternatively, the geographic location may be received 302 from other suitable devices.

The processing device determines 304 an authorized frequency band associated with the geographic location. In the exemplary embodiment, the processing device utilizes a look-up table that lists a plurality of geographic locations and an authorized frequency band associated with each geographic location, such as frequency look-up table 224 (shown in FIG. 2). Alternatively, the processing device may determine 304 the authorized frequency band using other suitable methods.

The geographic location and/or authorized frequency band are displayed 306 on a display device, such as display device 242 (shown in FIG. 2). Accordingly, a user can view the geographic location and/or authorized frequency band by viewing the display device. With the authorized frequency band determined 304, the processing device instructs 308 a transmitter/receiver module to transmit a radio signal within the authorized frequency band.

In response to the transmitted signal, an RFID tag generates a radio response signal that is received 310 by the RFID reader. The RFID reader and RFID tag may be incorporated as part of an RFID system onboard a vehicle, such as an aircraft. The processing device, transmitter/receiver module, display device, sensor module, and/or user interface module may be implemented in an RFID reader, such as RFID reader 102 (shown in FIG. 1).

The embodiments described herein facilitate operation of an RFID reader. The RFID reader determines an authorized frequency band based on the geographic location of the RFID reader. A transmitter/receiver unit of the RFID reader operates at the authorized frequency band. Accordingly, the RFID reader is capable of operating in a plurality of geographic locations and complying with local frequency regulation.

Unlike at least some known RFID systems that would require a dedicated RFID reader for each geographic region having a different authorized frequency band, the RFID reader described herein can be implemented in a mobile operating environment relatively easily. Further, as compared to manually checking vehicle equipment, the RFID reader described herein improves the quality, speed, and consistency of an equipment check. Moreover, the RFID reader described herein enables persistent, automated visibility of vehicle equipment, such as maintenance and/or safety equipment onboard an aircraft.

The embodiments described herein may utilize executable instructions embodied in a computer readable medium, including, without limitation, a storage device or a memory area of a computing device. Such instructions, when executed by one or more processors, cause the processor(s) to perform at least a portion of the methods described herein. As used herein, a “storage device” is a tangible article, such as a hard drive, a solid state memory device, and/or an optical disk that is operable to store data.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose various embodiments, which include the best mode, to enable any person skilled in the art to practice those embodiments, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A radio-frequency identification (RFID) reader comprising:
a transmitter/receiver module configured to transmit a radio signal on a plurality of frequency bands; and
a control module configured to:
receive a geographic location;
determine an authorized frequency band associated with the geographic location; and
instruct said transmitter/receiver module to transmit the radio signal on the authorized frequency band.

2. An RFID reader in accordance with claim 1, further comprising a sensor module configured to determine the geographic location, wherein said control module is configured to receive the geographic location from said sensor module.

3. An RFID reader in accordance with claim 1, further comprising a user interface module configured to receive a user input indicative of the geographic location, wherein said control module is configured to receive the geographic location from said user interface module.

4. An RFID reader in accordance with claim 3, wherein said user interface module comprises a toggle switch that enables a user to selectively change the geographic location received by said control module.

5. An RFID reader in accordance with claim 3, wherein said user interface module comprises a display device configured to display at least one of the geographic location and the authorized frequency band.

6. An RFID reader in accordance with claim 1, wherein said control module is configured to determine the authorized frequency band by utilizing a frequency look-up table listing a plurality of possible geographic locations and a frequency band associated with each of the plurality of possible geographic locations.

7. An RFID reader in accordance with claim 1, wherein said transmitter/receiver module is further configured to receive a response radio signal from an RFID tag coupled to an article onboard an aircraft.

8. An RFID reader in accordance with claim 1, wherein said control module is configured to determine an authorized frequency band in a range of 850 to 960 megahertz.

9. A processing device configured to:
receive a geographic location;
determine an authorized frequency band associated with the geographic location; and
instruct a transmitter/receiver module of a radio-frequency identification (RFID) reader to transmit a radio signal on the authorized frequency band.

10. A processing device in accordance with claim 9, wherein said processing device is configured to receive the geographic location from a global positioning system.

11. A processing device in accordance with claim 9, wherein said processing device is configured to receive the geographic location from a user interface module that enables a user to selectively change the geographic location.

12. A processing device in accordance with claim 9, wherein said processing device is configured to determine the authorized frequency band by utilizing a frequency look-up table including a plurality of possible geographic locations and a frequency band associated with each geographic location.

13. A method for transmitting a radio signal from a radio-frequency identification (RFID) reader, said method comprising:
receiving, at a processing device, a geographic location;
determining, using the processing device, an authorized frequency band associated with the geographic location; and
instructing a transmitter/receiver module of the RFID reader to transmit a radio signal on the authorized frequency band.

14. A method in accordance with claim 13, wherein receiving a geographic location comprises receiving the geographic location from a sensor module configured to determine the geographic location.

15. A method in accordance with claim 13, wherein receiving a geographic location comprises receiving the geographic location from a user interface module configured to receive a user input indicative of the geographic location.

16. A method in accordance with claim 13, wherein receiving a geographic location comprises receiving the geographic location based on a position of a toggle switch that enables a user to selectively change the geographic location.

17. A method in accordance with claim 13, further comprising displaying at least one of the geographic location and the authorized frequency band on a display device.

18. A method in accordance with claim 13, wherein determining an authorized frequency band comprises determining the authorized frequency band by utilizing a frequency look-up table listing a plurality of possible geographic locations and a frequency band associated with each of the plurality of possible geographic locations.

19. A method in accordance with claim 13, further comprising receiving, at the RFID reader, a radio response signal from an RFID tag coupled to an article onboard an aircraft.

20. A method in accordance with claim 13, wherein determining an authorized frequency band comprises determining an authorized frequency band in a range of 850 to 960 megahertz.
